(19) United States
(12) Patent Application Publication
(10) Pub. No.: US 2006/0290627 A1
(43) Pub. Date: Dec. 28, 2006

(54) Illumination device and display apparatus having the same

(76) Inventors: Akitoyo Konno, Hitachi (JP); Tsunenori Yamamoto, Hitachi (JP); Ikuo Hiyama, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/472,401

(22) Filed: Jun. 22, 2006

(30) Foreign Application Priority Data
Jun. 23, 2005 (JP) 2005-183583

(51) Int. Cl. G09G 3/36

(52) U.S. Cl. 345/87

(57) ABSTRACT

An illumination device is partitioned into a plurality of areas. Rays of light emanating from light sources 203 of individual units are intercepted appropriately by means of a light barrier 204 and the transmission factor at individual positions of a light diffuser 205 is changed in accordance with light flux reaching the light diffuser 205. The transmission factor at individual positions of a liquid crystal panel is controlled in accordance with a luminance unevenness distribution of the illumination device.

### BACKGROUND OF THE INVENTION

The present invention relates to an illumination device having a plurality of divisional areas to control the luminance area by area and a light transmission type display apparatus provided with the illumination device.

Principally, the display apparatus can be classified into a luminous type display apparatus such as a CRT (cathode ray tube) or plasma display panel and a non-luminous type display apparatus such as a liquid crystal display or electrochromic display.

The non-luminous type display apparatus is further sorted into one using a reflection type light modulator for adjusting the quantity of light of reflection in accordance with an image signal and the other using a transmission type light modulator for adjusting the quantity of light of transmission in accordance with an image signal.

Especially, a liquid crystal display apparatus using a liquid crystal display component (also called a liquid crystal display panel) as a transmission type light modulator and having on its back an illumination device (also termed a backlight) is characteristic of small thickness and light weight and is therefore adopted as a monitor of computer or a television (also called a TV), finding its application to various kinds of display apparatus.

As a light source of the illumination device, a cold cathode fluorescent light (CCFL), a light emitting diode (LED) or an organic light emitting diode (OLED) is used.

The liquid crystal display apparatus, however, suffers a problem that during display of a moving picture, the image blurs or the contrast ratio is degraded to slightly decrease the clearness of the image.

In principle, for display in the liquid crystal display apparatus, twisted nematic (TN) is mainly used and in addition thereto, in-plane switching (IPS) or multi-domain vertical alignment (MVA) featuring wide view angles is used. In any case, an image is formed by illuminating rays of illumination light from an illumination device disposed on the back of a display section onto a liquid crystal panel adapted to control the transmission factor for the illumination light rays.

In the conventional liquid crystal display apparatus, a moving picture is caused to blur on account of a delayed response speed of liquid crystal and a display of hold type. Except for a specially designed liquid crystal display apparatus, the general apparatus employs a liquid crystal requiring a response time of several milliseconds to several of tens of milliseconds.

Accordingly, when the display image changes every moment as in the case of a moving picture, a change in transmission factor precedes a sufficient optical response of liquid crystal to written image data and a transitional state of this change is also displayed causing the human eyes to detect a blur. Further, in the conventional liquid crystal display apparatus, the illumination device constantly keeps turning on and consequently, an image displayed for a frame remains until an instant of rewrite for the next frame.

The display type as above is called a hold type display and because of miss matching between the hold type display and visual characteristics of human eyes, the moving picture blurs as described in The Institute of Electronics, Information and Communication Engineers of Japan, Technical Report EID2001-84, pp. 13-18 (2002-01). The reference also describes a technique of intermittently lighting an illumination device to cure the blur in moving picture due to the response of liquid crystal and the blur in moving picture due to mismatch between the hold type display and the visual characteristics of human eyes.

The illumination device used in the liquid crystal display apparatus can be classified into two main types in accordance with the screen size of the apparatus. Generally, a side light type as shown in FIG. 19 is used as an illumination device for a liquid crystal display apparatus of small size and a direct type as shown in FIG. 20 is used for a large-size apparatus.

In the side light type shown in FIG. 19, a light source is arranged at one end of a display panel and rays of light from the light source are guided through a light diffuser plate. The rays of light traveling into the light diffuser plate are totally reflected at a surface on the display screen side and at a surface opposite thereto so as to be guided in the light diffuser plate. The opposite surface the light diffuser plate has in opposition to the display screen is mounted with a light scattering layer and the rays of light are scattered at that layer so as to be extracted at the display screen. The scattering layer includes, for example, a white dot pattern formed through silk printing process.

In the direct type shown in FIG. 20, light sources are arranged just under the display screen. The light sources are covered with a light diffuser so that their shapes can be unseen and uniformized to provide a planar light source which in turn illuminates the display panel. In general, a condensing sheet such as a prism sheet is used on the light diffuser to assure optical directivity to some extent. In the case of the direct type, the plural light sources are typically used and lighting can be controlled light source by light source.

Incidentally, for the purpose of curing blur of a moving picture in the hold type display, a method is available according to which in the direct type illumination device as shown in FIG. 20, the luminous surface is partitioned into a plurality of areas each of which is deemed as a unit and light sources in association with the individual units are sequentially lit unit by unit in accordance with a response state of liquid crystal.

In the example shown in FIG. 20, the luminous surface is quartered in the scanning direction, that is, longitudinal direction and divisional areas are called unit 1 to unit 4 in sequence from the top. Generally, in the liquid crystal display apparatus, data is sequentially written in liquid crystals from up to down. This operation is called “scan”.

Individual liquid crystals respond to transmission factors complying with the data in order of write of data. Luminance response waveforms the light sources corresponding to the individual units in FIG. 20 have are illustrated in FIG. 21A and transmission factor response waveforms the individual liquid crystals laid on the individual units are illustrated in FIG. 21B.

The liquid crystal requires a response time of typically several milliseconds following write of data. Therefore, each light source of each unit is lit at the termination of the response of the liquid crystal on each unit. Through this, blur of a moving picture due to a delay in transmission factor response the liquid crystal has can be cured.

Further, the light source of each unit repeats turn-on and turn-off and as a result, intermittence of the display image can be assured. Thus, the blur of a moving picture in the hold type display can be cured.

The technique for partitioning the illumination device into units and performing sequential lighting in the units is described in, for example, Japanese Patent No. 3618066.

Typically, however, the light diffuser is provided above the light sources of the direct type illumination device as described previously and therefore, even when the light sources are controlled independently unit by unit, rays of light from the light source of a unit illuminates another unit, too. Consequently, intermittence of a display image is difficult to achieve, raising a problem that the alleviative effect of moving picture blur is degraded.

JP-A-2001-318614 describes a counterplot against this problem, according to which a light barrier is interposed between units to suppress intrusion of rays of light to a different area appropriately and repress a luminance unevenness generated by the provision of the light barrier. The luminance unevenness referred to herein means that a dark line or bright line is generated at a portion where a projection of the light barrier exists as demonstrated when the luminance distribution on the light diffuser is measured in the presence of the light barrier laid between units. In this reference, to cope with this problem, two spaced-apart diffuser plates are provided to prevent the luminance unevenness.

In another method described in JP-A-2001-311932, light sources are controlled unit by unit and an optical shutter is disposed to illuminate a specified area.

### SUMMARY OF THE INVENTION

In the background arts as above concerning the technology in which the illumination device is partitioned into a plurality of units so that intrusion of rays of light emanating from a light source of each unit into another unit may be suppressed appropriately, a light barrier is provided between the units to repress the intrusion of rays of light emanating from each unit into a different unit. The light barrier gives rise to generation of a luminance unevenness on the light diffuser but the luminance unevenness can be prevented by using two light diffusers. Disadvantageously, however, this conventional construction leads to low efficiency and an increase in cost.

In the method of providing an optical shutter, the optical shutter section and its drive system are required and disadvantageously, the cost rises correspondingly.

In the light of disadvantages of the prior arts, the present invention provides a technique for realizing an illumination device or a light transmission type display apparatus in which intrusion of rays of light into a different area can be suppressed appropriately without substantially decreasing the efficiency and a luminance unevenness can be eliminated.

According to the present invention, in a light transmission type display apparatus having an illumination device partitioned into a plurality of units so that lighting of light sources may be controlled unit by unit, a light barrier is provided for appropriately suppressing intrusion of rays of light emanating from each unit into another area and the transmission factor at individual positions of a light diffuser spaced apart from the light sources through an arbitrary gap is changed in accordance with a distribution of light flux emanating from the light sources and reaching the light diffuser.

Also, according to the invention, in a light transmission type display apparatus having an illumination device partitioned into a plurality of units so that lighting of light sources may be controlled unit by unit, a light barrier is provided for appropriately suppressing intrusion of rays of light emanating from each unit into another area and the density of light scattering particles at individual positions of a light diffuser spaced apart from the light sources through an arbitrary gap is changed in accordance with a distribution of light flux emanating from the light sources and reaching the light diffuser.

According to the invention, in a light transmission type display apparatus having an illumination device partitioned into a plurality of units so that lighting of light sources may be controlled unit by unit, an LED is used as the light source, a prism sheet is arranged on the surface of transparent resin by which a light emitting portion of the LED is separated from the air atmosphere, and the transmission factor at individual positions of a light diffuser spaced apart from the light sources through an arbitrary gap is changed in accordance with a distribution of light flux emanating from the light sources and reaching the light diffuser.

Further, according to the invention, in a light transmission type display apparatus having an illumination device partitioned into a plurality of units so that lighting of light sources may be controlled unit by unit, an LED is used as the light source, the surface of transparent resin by which a light emitting portion of the LED is separated from the air atmosphere is formed unevenly and the transmission factor at individual positions of a light diffuser spaced apart from the light sources through an arbitrary gap is changed in accordance with a distribution of light flux emanating from the light sources and reaching the light diffuser.

Further, according to the present invention, in a light transmission type display apparatus having an illumination device partitioned into a plurality of units so that lighting of light sources may be controlled unit by unit, the transmission factor is changed in accordance with a distribution of luminance on a light diffuser or on a light condensing sheet arranged on the light diffuser.

As described above, according to the present invention, in a light transmission type display apparatus having an illumination device partitioned into a plurality of areas so that the luminance of the illumination device may be controlled area by area, the quantity of intrusion of rays of light emanating from the light source of each area into a different area can be controlled appropriately and meantime, a uniform luminance distribution can be set up over the whole of illumination device.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram useful to explain the overall construction of embodiment 1.

FIG. 2 is a time chart for explaining an illumination device drive sequence in the embodiment 1.

FIG. 3 is a diagram for explaining the construction of a conventional illumination device.

FIG. 4 is a diagram for explaining the construction of another conventional illumination device.

FIG. 5 is a diagram for explaining the construction of an illumination device in the embodiment 1.

FIG. 6 is a diagram for explaining the effects of the embodiment 1.

FIG. 7A is a diagram useful to explain the overall construction of embodiment 2.

FIG. 7B is a sectional view taken on line A-A′ in FIG. 7A.

FIG. 8 is a diagram for explaining the construction of a light source in the embodiment 2.

FIG. 9 is a diagram useful to explain the overall construction of embodiment 3.

FIGS. 10A and 10B are diagrams for explaining the contents of the embodiment 3.

FIGS. 11A and 11B are diagrams for explaining the construction of a light source in the embodiment 3.

FIG. 12 is a diagram for explaining the construction of an illumination device in the embodiment 3.

FIGS. 13A to 13C are diagrams for explaining the construction of a light source according to embodiment 4.

FIG. 14 is a block diagram useful to explain the overall construction of embodiment 5.

FIG. 15 is a diagram for explaining the construction of an illumination device in the embodiment 5.

FIG. 16 is a diagram showing a luminance distribution of the illumination device in the embodiment 5.

FIG. 17 is a diagram showing the transmission factor of a liquid crystal panel in the embodiment 5.

FIG. 18 is a diagram showing the luminance on the liquid crystal panel in the embodiment 5.

FIG. 19 is a diagram showing the construction of a backlight of side light type.

FIG. 20 is a diagram showing the construction of a backlight of direct type.

FIGS. 21A and 21B are time charts for explaining a method for improving the performance of a moving picture.

### DETAILED DESCRIPTION OF THE EMBODIMENTS

The present invention will now be described by way of example with reference to the accompanying drawings.

### Embodiment 1

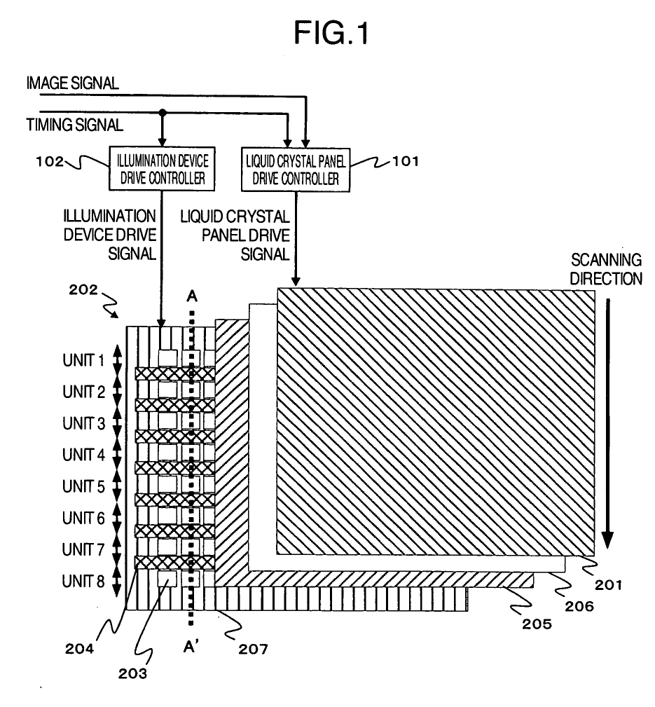

Referring first to FIG. 1, there is illustrated the overall construction of the present embodiment in schematic block diagram form. In the present embodiment, a liquid crystal display apparatus is used as an example of display apparatus.

In the present embodiment, an image signal and a timing signal which are sent from an image signal source are received by a liquid crystal panel drive controller 101 which in turn drives a liquid crystal panel 201.

Generally, in the liquid crystal panel 201, an image is sequentially written starting from the uppermost line, ultimately being written on the lowermost line. This operation is called “scan” and the direction in which the image is written in sequence is called a scanning direction. Hereinafter, the scanning direction will be defined as indicating a direction oriented from to bottom on the screen.

An illumination device controller 102 receives the timing signal sent from the image signal source to drive an illumination device 202. In the illumination device 202, a light emitting diode is used as light source 203.

The light sources 203 are arranged vertically and horizontally in the form of a mesh and in the scanning direction, a light barrier 204 is interposed between adjacent light sources 203. In the present embodiment, the light emitting diode is used but this is not limitative and another type of light source such as a cold cathode fluorescent light may also be used.

A light diffuser 205 overlies the light sources 203 by being spaced apart therefrom with a certain gap intervened, a light condensing sheet 206 is laid on the diffuser 205 and the liquid crystal panel 201 is laid on the sheet.

In the present embodiment, one light condensing sheet 206 is sandwiched between light diffuser 205 and liquid crystal panel 201 but this is not particularly limitative and various combinations are conceivable including sandwiching of two light condensing sheets or intervention of a thin diffuser sheet, together with direct arrangement of the liquid crystal panel 201 on the light diffuser 205 in case wide audible and visible angles are desired.

The light sources 203, light barrier 204, light diffuser 205 and light condensing sheet 206 are fixedly put together by means of a housing 207. Herein, a structure of the light sources 203, light barrier 204, light diffuser 205 and housing 207 for supporting them corresponds to the illumination device 202.

Although not illustrated, a light scattering sheet having a high reflection factor is bonded to the surface of light barrier 204 and to the inner surface of housing 207.

In the present embodiment, the illumination device is partitioned into 8 areas in the scanning direction and the respective areas will be called “units”.

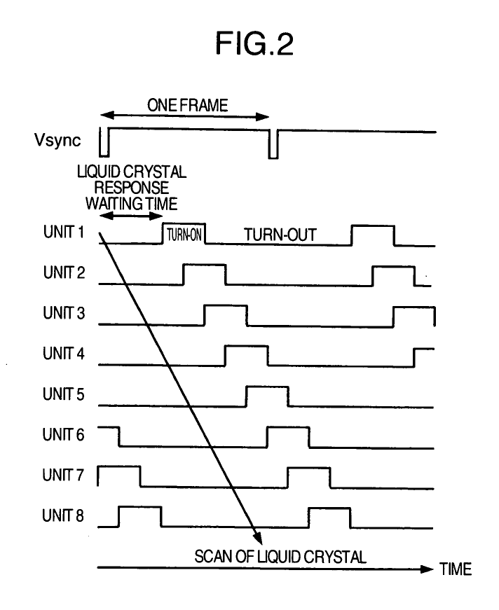

Lighting sequence of the light sources 203 in the individual units of illumination device 202 in the present embodiment is depicted in a time chart of FIG. 2. The light sources 203 are controllable independently unit by unit and as shown in FIG. 2, the individual units are sequentially caused to luminesce in order of unit 1 to unit 8 during a period amounting to a quarter of one frame.

Luminescence of light sources of each unit is started after a response time of liquid crystal has elapsed in course of scan of liquid crystal. In this manner, visibility of a moving picture can be improved.

Here, the sequential luminescence from unit 1 to unit 8 proceeds over one frame period but one frame occurs 60 times per second and hence human eyes can visually perceive constant luminescence of all of the units.

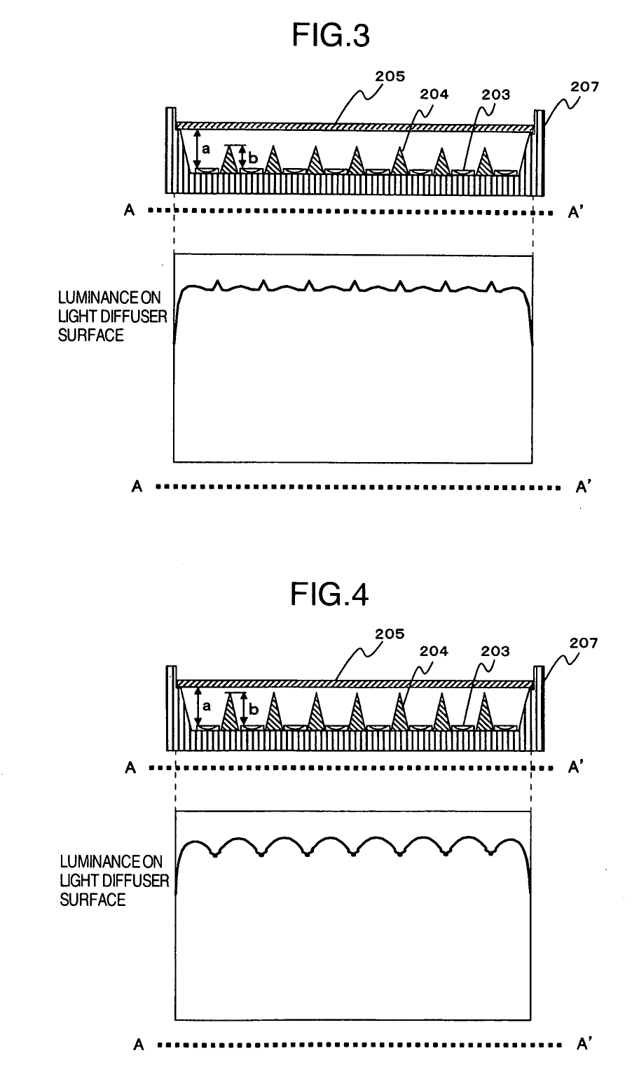

In connection with two kinds of conventional illumination devices, sectional views taken on line A-A′ in FIG. 1 and luminance distributions on the light diffuser surface along the section line are illustrated in FIGS. 3 and 4.

Firstly, illustrated in FIG. 3 is the case where the distance between light source 203 and light diffuser 205 is a and the height at the apex of light barrier from the light source 203 is b which satisfies b=0.7a. In this case, such a luminance unevenness that the luminance is higher in close proximity to the apex of light barrier 204 than in the neighborhood thereof is generated.

Next, illustrated in FIG. 4 is the case where b=0.9a. In this case, a luminance unevenness is generated in which the luminance is lower in close proximity to the apex than in the neighborhood thereof.

To cure the luminance unevenness as above, (1) a method for prolonging the distance between light diffuser 205 and light source 203 and (2) a method for increasing the transmission factor of light diffuser 205 are conceivable. The method (1) raises a problem that the thickness of the display apparatus as a whole increases and a problem that rays of light emanating from the individual units diverge to a wide range to degrade the performance of a moving picture and for these reasons cannot be applied. The method (2), on the other hand, faces a problem that the efficiency of the illumination device as a whole is lowered.

In the light diffuser 205 of the above structure, rays of light are incident on internally existent fine particles (scattering resin) and scattered in random directions and therefore, the light diffuser 205 functions to diverse rays of light having strong rectilinear propagation directivity to a wide range, thereby unifying the luminance. Of rays of light scattered in random directions, some components are returned to the interior of the illumination device. These components partly impinge upon the light scattering sheet so as to again reach the light diffuser 205 and partly undergo absorption by the light scattering sheet and light source 203, ultimately being extinguished.

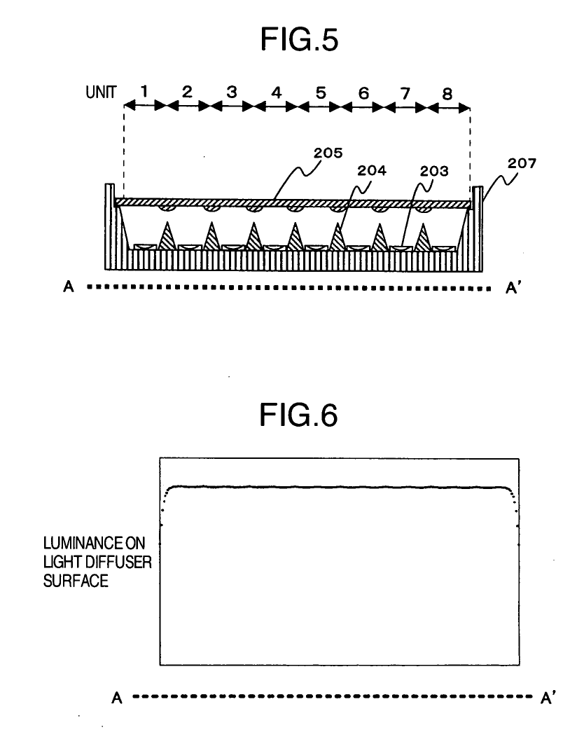

Turning now to FIG. 5, the illumination device 202 used in the present embodiment is illustrated in sectional form taken on line A-A′ in FIG. 1. A light barrier 204 having the same height as that in FIG. 3 defined by b=0.7a is used herein.

Conceivably, in FIG. 5, an apex portion of light barrier 204 will be brightened, that is, the light flux is concentrated on that portion. Then, by decreasing the transmission factor of light diffuser 205 at the portion where the light flux is concentrated, the luminance of the surface of light diffuser 205 can be decreased at that portion and the luminance can be unified as a whole.

In the present embodiment, the transmission factor can be changed by changing the thickness of light diffuse 205 in accordance with a distribution of light flux reaching the light diffuser 205.

As a result, the luminance unevenness generated just above the apex of light barrier 204 in FIG. 3 can be cured as shown in FIG. 6. Further, since the thickness of the whole of light diffuser 205 is not increased, the efficiency of luminance does not fall down substantially.

It will be appreciated that the light diffuser 205 is produced through injection molding and therefore, the thickness can be changed location by location by shaping the mold correspondingly. Further, in comparison with the case where the thickness of light diffuser 205 is increased all over the surface, the partially or locally increased thickness can give rise to a reduction in the material cost.

Accordingly, without being accompanied by a large increase in cost, the production can be accomplished.

In the present embodiment, by changing the thickness of the light diffuser 205, the transmission factor can be changed to cure the luminance unevenness but this is not limitative and the transmission factor can also be changed by changing the density of light scattering particles in the light diffuser 205.

And besides, in the present embodiment, the illumination device 202 is partitioned into 8 units but this is not limitative and design can be made optimally in compliance with the screen size and utilization purpose. By further increasing the number of divisional units, the transmission factor response timing of liquid crystal at each position can match the lighting timing of each unit more precisely.

As described above, according to the present embodiment, the intrusion of rays of light emanating from each unit into a different unit can be suppressed by means of the light barrier 204 and a luminance unevenness attributable to the light barrier 204 can be eliminated without resort to a substantial decrease in the efficiency by changing the thickness of light diffuser 205 locally or position by position.

### Embodiment 2

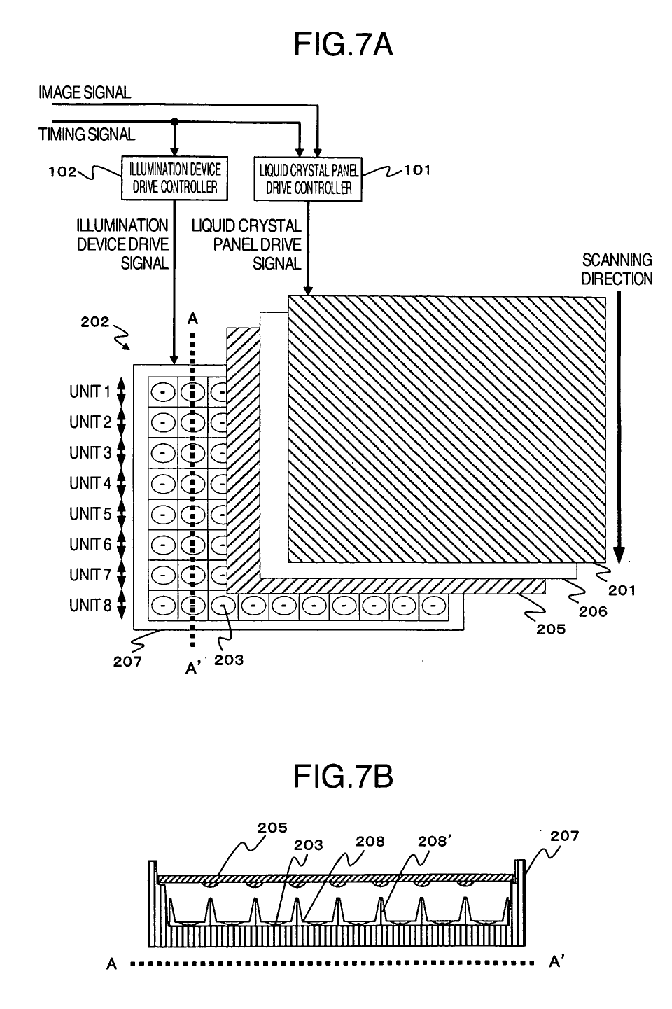

The present embodiment offers a technique for making the light barrier 204 at low costs. The overall construction in the present embodiment is illustrated in FIG. 7A and a section taken on line A-A′ in FIG. 7A is illustrated in FIG. 7B.

With reference to FIG. 7A, an image signal and a timing signal which are sent from an image signal source are received by a liquid crystal panel drive controller 101 which in turn drives a liquid crystal panel 201. An illumination device drive controller 102 receives the timing signal sent from the image signal source to drive an illumination device 202.

In the present embodiment, like the embodiment 1, the illumination device 202 is partitioned into 8 units in the scanning direction and as has been described with reference to FIG. 2, turn-on/turn-off of light sources 203 is controlled unit by unit to cause the units 1 to 8 to luminesce sequentially in this order.

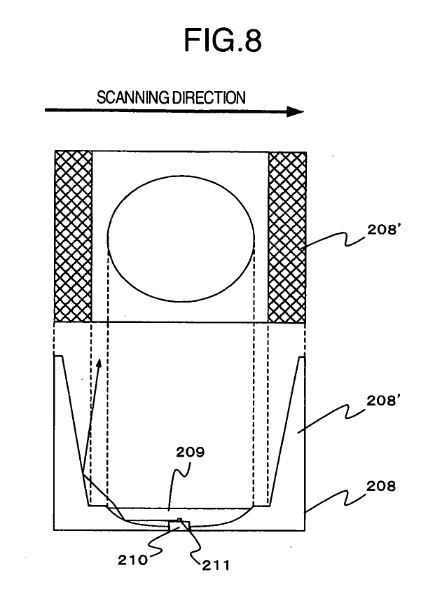

The present embodiment features formation of a projection 208′ on a mold resin member 208 of a light emitting diode as shown in FIGS. 7B and 8.

The ordinary mold resin member 208 devoid of the projection 208′ functions to fulfill (1) upward extraction of rays of light emanating from a light emitting portion 211 and (2) assisting in filling the light emitting portion 211 with transparent resin 209.

To detail (1) above, rays of light emanate from the light emitting portion 211 in various directions including upward direction and right and left directions and in the absence of the ordinary mold resin member 208, rays of light cannot be extracted upwards efficiently. For this reason, the ordinary mold resin member 208 spherically encompasses the peripheral edge of the light emitting portion 211, so that rays of light emanating laterally of the light emitting portion 211 are reflected at a spherical portion of the ordinary mold resin member 208 so as to travel upwards.

To detail (2) as above, the ordinary mold resin member 208 is filled at its spherical portion with transparent resin 209 to protect the light emitting portion 211 and an electrode 210 for passing current therethrough. Further, the light emitting portion 211 has a relatively high reflection factor and consequently, if the light emission interface region is the air atmosphere, rays of light undergo total reflection inside the light emitting portion 211 to degrade the efficiency of light extraction. Accordingly, the transparent resin 209 is filled to alleviate the total reflection inside the light emitting portion 211 and promote the light extraction efficiency.

The ordinary mold resin member 208 fulfills the above functions and is therefore not particularly added with the projection 208′. The present embodiment features that the mold resin member 208 is made projective by adding upper and lower projections 208′ in the scanning direction which jut out toward the light diffuser 205, thereby adding the light barrier with a new function.

This can eliminate the necessity of separate provision of the light barrier 204 to assure light shielding function at low costs. Since the mold resin member 208 can be worked through injection molding process, the mold resin member having the projections can be made easily by changing the mold used for injection molding.

In the present embodiment, too, as in the case of the embodiment 1, the projections 208′ added to the mold resin member 208 function as a light barrier and by designing the thickness distribution of the light diffuser 205, the luminance unevenness attributable to the light barrier can be prevented, thus materializing the illumination device 202 having uniform luminance on the light diffuser 205.

### Embodiment 3

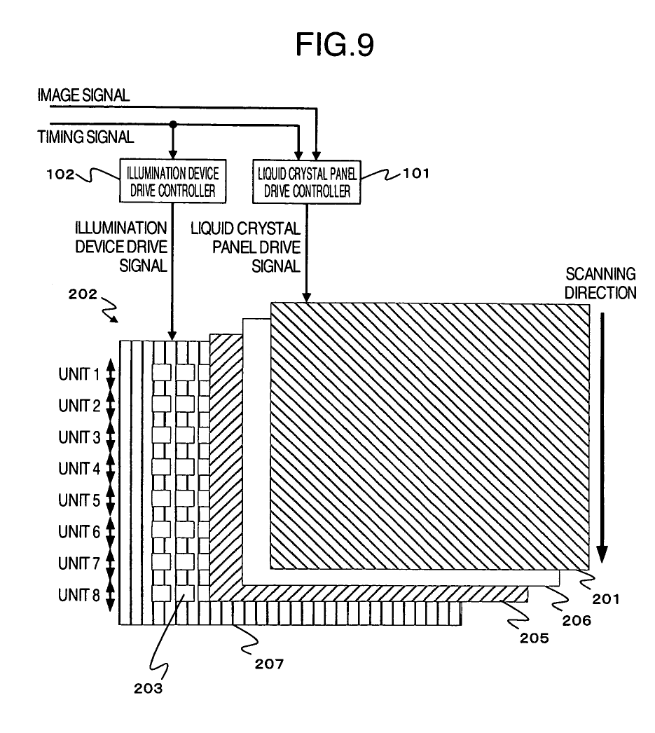

Referring now to FIG. 9, the overall construction of the present embodiment is illustrated. In the present embodiment, an image signal and a timing signal which are sent from an image signal source are received by a liquid crystal panel drive controller 101 which in turn drives a liquid crystal panel 201. An illumination device drive controller 102 receives the timing signal sent from the image signal source to drive an illumination device 202.

In the present embodiment, too, the illumination device 202 is partitioned into 8 units in the scanning direction as in the case of the embodiment 1 and turn-on and turn-off of light sources 203 is controlled unit by unit so that the units 1 to 8 may be turned on sequentially in this order as shown in FIG. 2.

A light diffuser 205 is spaced apart from the light sources 203 through an appreciable gap, a light condensing sheet 206 overlies the diffuser 205 and a liquid crystal panel 201 is laid on the sheet 206. Although not illustrated, a light scattering sheet having a high reflection factor is bonded to the inner surface of a housing 207.

According to the present embodiment, the illumination device 202 has the light sources 203 materialized with light emitting diodes and by contriving the structure of the light emitting diodes, intrusion of rays of light emanating from each unit to a different unit is suppressed appropriately.

Typically, the light emitting surface of the light emitting diode is equivalent to the surface of transparent resin 209 filled in the mold resin member 208 as shown in FIG. 8, the transparent resin surface being an interface to the air atmosphere.

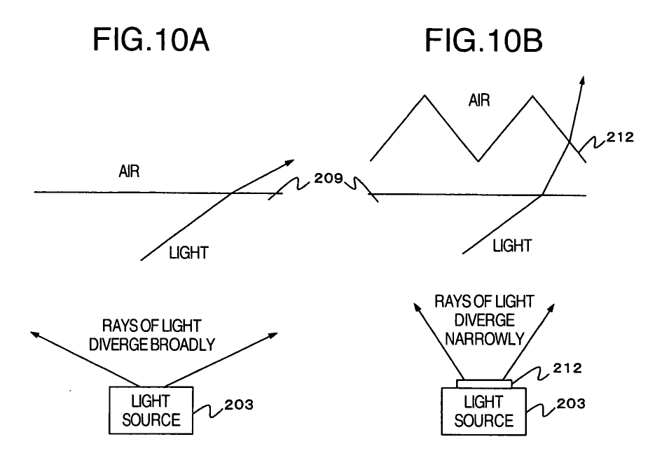

The directivity of rays of light emanating from the light emitting surface is determined by the emission directivity of light emitting portion 211, the difference in refractive index between air and transparent resin 209 and the curvature of a spherically shaped portion of the mold resin member 208. Rays of light emanating from the transparent resin 209 to the air atmosphere, however, diverge to a wide range as shown in FIG. 10A. Accordingly, rays of light emanating from each unit are distributed broadly to a different unit, making it difficult to improve the performance of a moving picture.

Then, in the present embodiment, a prism sheet 212 is laid on the surface of transparent resin 209 as shown in FIG. 10B. Typically, the prism sheet 212 is used as a light condensing sheet with a view to brightening the frontal direction of the screen. In the present embodiment, the light condensing sheet is used particularly for controlling the light emission directivity of the light source 203.

The prism sheet 212 has a surface of indented form which is effective to refract rays of light, thus promoting the light emission directivity in upward direction. Accordingly, by arranging the prism sheets 212 in such a way that the indentation reiterates in the scanning direction, divergence of rays of light from each unit can be repressed appropriately.

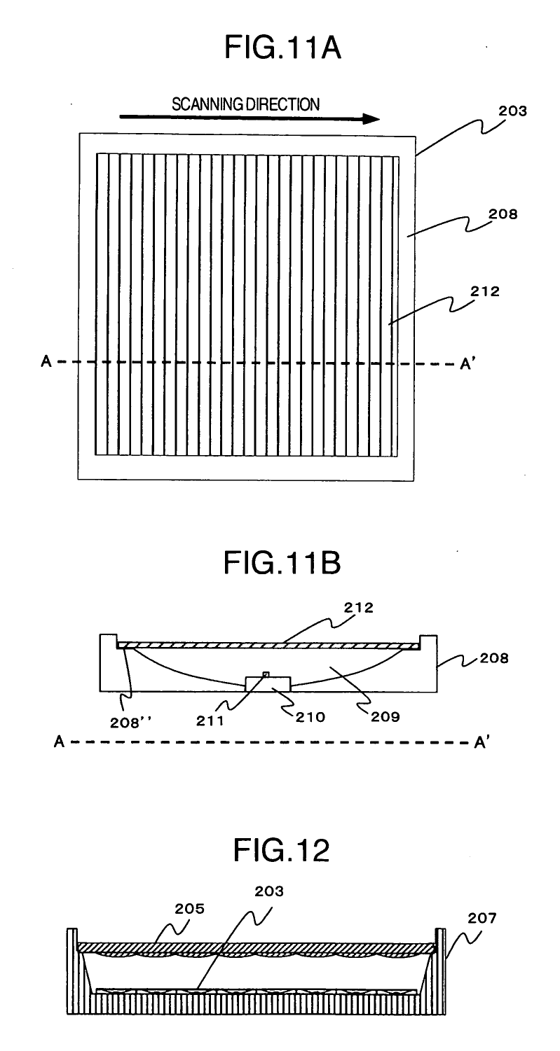

Turning now to FIGS. 11A and 11B, how to arrange the prism sheet 212 in relation to the light source 203 in the present embodiment will be described. As the prism sheet 212, one sheet corresponding to the screen size may be arranged all over the light sources but such a sheet fulfils itself only at the light emitting portion of each light source 203, thus degrading the efficiency of cost.

Then, a method is employed according to which a prism sheet piece is arranged only at the light emitting portion of each light source 203. More specifically, a rectangular groove is formed in the mold resin member 208, the bottom of the groove is further grooved into a spherical form and the transparent resin 209 is filled in the spherical groove. Part of the rectangular groove corresponding to the outer peripheral edge of the spherical groove is used as a bonding portion 208″ to which the prism sheet 212 is bonded.

The direction of the prism sheet 212 can be stipulated by the rectangular groove. Namely, the individual light sources 203 are arranged in the illumination device such that the minor side of the rectangular is parallel with the scanning direction and the prism sheet 212 is formed into pieces having indented patterns reiterated in the minor side direction and after being fitted in the rectangular groove in mold resin member 208, it is bonded to the peripheral edge of the groove.

In this manner, divergence of rays of light in the direction of formation of the divisional units can be suppressed and intrusion of rays of light from each unit to a different unit can be repressed.

In the present embodiment, the use of the light barrier is excluded but this is not limitative and with the light barrier used, the intrusion of rays of light from each unit to a different area can be prevented to further improve the performance of a moving picture.

The structure of illumination device 202 in the present embodiment is illustrated in sectional form in FIG. 12. To obtain the uniformity of luminance, the thickness of the light diffuser 205 is changed in compliance with positions.

As described above, in the present embodiment, by introducing the prism sheet 212 for the light sources 203, the intrusion of rays of light from each unit into a different unit can be suppressed appropriately, thereby improving the moving picture performance. In addition, by changing the thickness of light diffuser 205 depending on positions, the luminance can be made to be uniform.

### Embodiment 4

The overall construction of the present embodiment is similar to that of the embodiment 3 shown in FIG. 9 and the drive sequence of illumination device is similar to that in the embodiment 1 shown in FIG. 2.

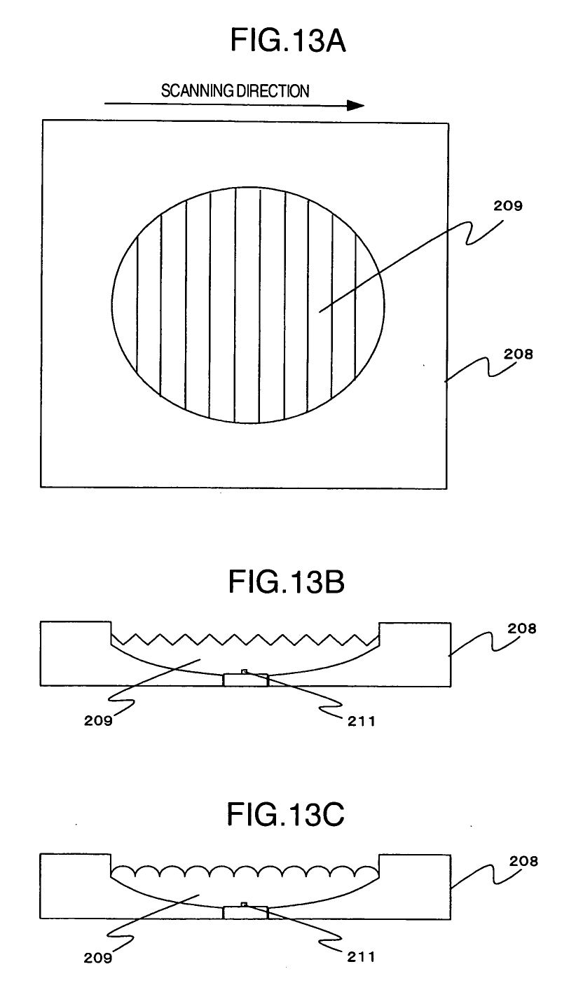

In the present embodiment, a light emitting diode is used as the light source. The light source in the present embodiment is structured as shown in FIG. 13. The light emitting diode used in the present embodiment features transparent resin member 209 having its surface formed unevenly.

An ordinary light emitting diode is formed by pouring transparent resin 209 into a spherical groove of mold resin member 208 and by thermally setting the resin 209. In this treatment, the transparent resin 209 generally finds its own level.

According to the present embodiment, the thermosetting of the transparent resin 209 is caused to proceed while an unevenly shaped metal mold being pressed on the transparent resin 209. Then, the mold is pulled out after completion of setting to permit the surface of transparent resin 209 to be shaped unevenly as shown in FIG. 13A. Depending on the shape of the mold, various shapes as shown in FIGS. 13B and 13C can be worked.

By making the surface of transparent resin 209 uneven in this manner, divergence of rays of light in the direction of reiteration of indentation can be repressed, attaining the effect similar to that obtained with bonding of the prism sheet in the embodiment 3.

As described above, according to the present embodiment, by making the surface of transparent resin 209 shaped unevenly in the scanning direction, the intrusion of rays of light emanating from each unit into a different unit can be suppressed and the moving picture performance can be improved.

### Embodiment 5

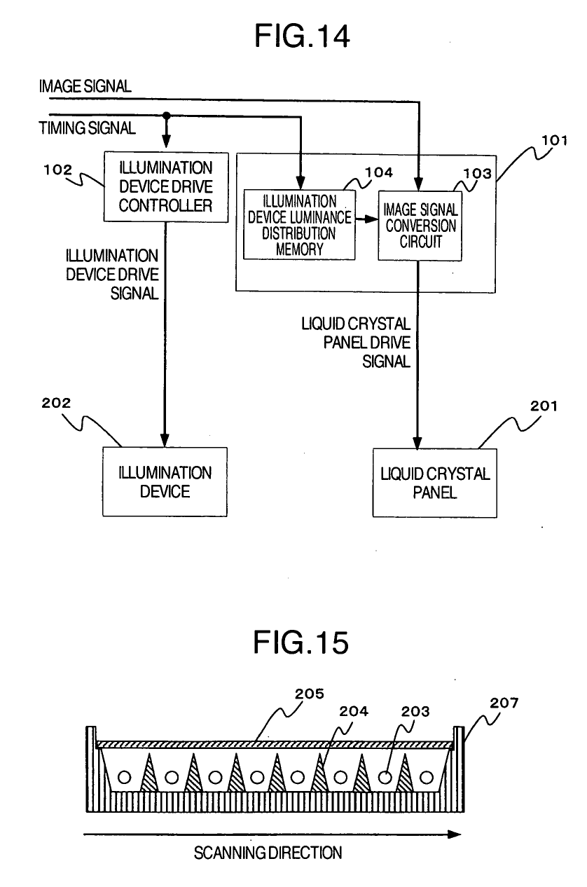

The overall construction of the present embodiment is illustrated in FIG. 14. In the present embodiment, an image signal and a timing signal which are sent from an image signal source are received by a liquid crystal panel drive controller 101 which in turn drives a liquid crystal panel 201. An illumination device drive controller 102 receives the timing signal sent from the image signal source to drive an illumination device 202.

The liquid crystal panel drive controller 101 includes an illumination device luminance distribution memory 104 written with data of luminance distribution in the scanning direction of the illumination device and an image signal conversion circuit 103 for suitably converting an input image signal in accordance with an inputted image signal and the contents of an output of the illumination device luminance distribution memory 104 and delivering a converted input image signal.

The liquid crystal panel 201 used in the present embodiment is an active matrix type liquid crystal panel having 768 lines.

The structure of the illumination device used in the present embodiment is illustrated in FIG. 15. A light barrier 204 is interposed between adjacent light sources 203 in the scanning direction.

In the present embodiment, a cold cathode fluorescent light is used as light source 203 but this is not limitative and a different type of light source such as a light emitting diode can also be used.

In the present embodiment, too, the illumination device 202 is partitioned into 8 units in the scanning direction as in the case of the embodiment 1 and turn-on/turn-off of the light sources 203 is controlled unit by unit to sequentially turn on the units 1 to 8 in this order.

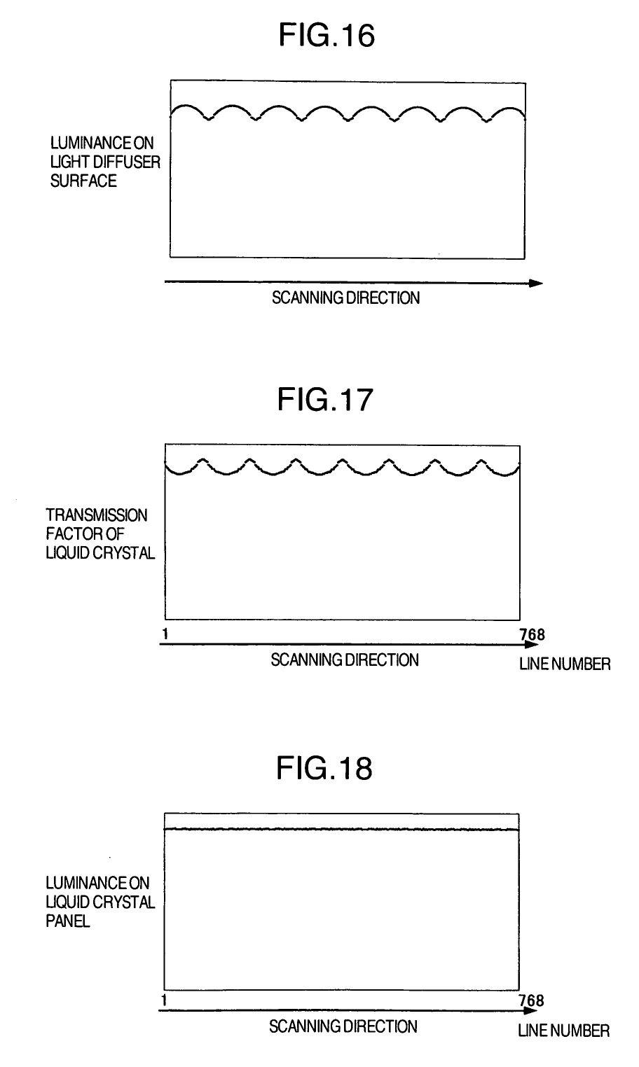

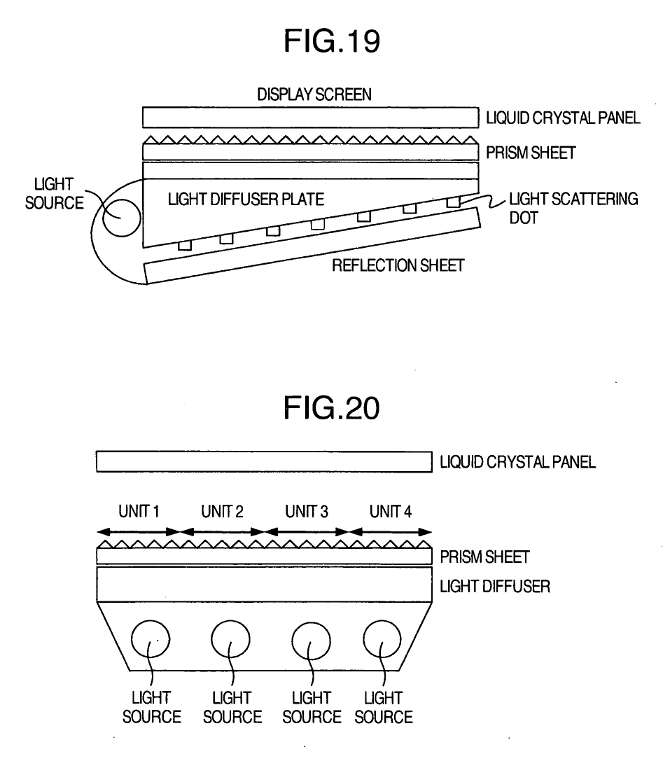

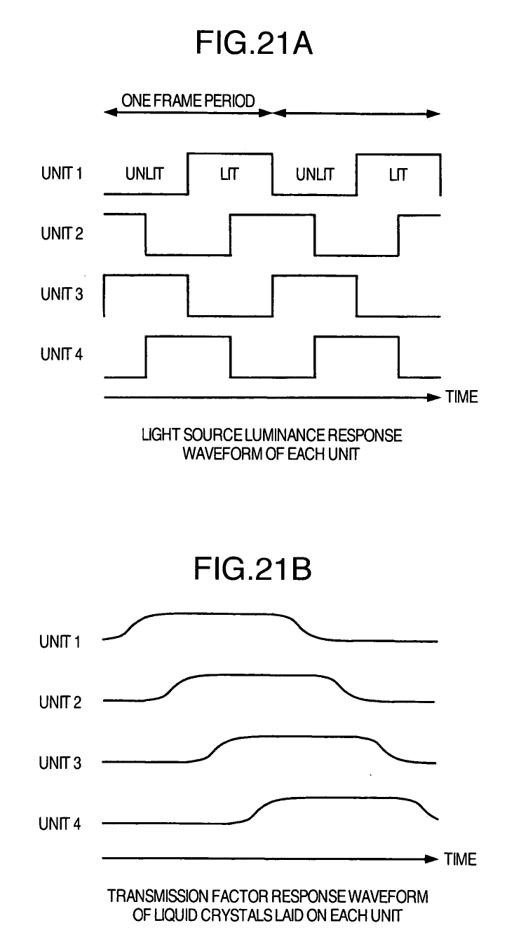

Referring to FIG. 16, a luminance distribution in the scanning direction of the illumination device is illustrated. Because of the arrangement of the light barriers 204, a luminance unevenness pattern is generated in the luminance distribution. This luminance unevenness generated in the illumination device 202 can be eliminated by controlling the transmission factor at individual positions of the liquid crystal panel 201 through the use of the converted image signal.

Typically, the liquid crystal panel is laid on the illumination device freed from the luminance unevenness and the transmission factor of liquid crystals is controlled by an image signal to display an image. That is to say, by controlling the transmission factor of liquid crystal, the luminance on the liquid crystal panel is changed.

Accordingly, if the luminance distribution on the illumination device 202 is known in advance, a level of luminance desired to be obtained on the liquid crystal panel can be acquired by controlling the liquid crystal transmission factor to an optimal value in accordance with the luminance distribution.

Then, in the present embodiment, the illumination device luminance distribution memory 104 is provided in the liquid crystal panel drive controller 101 to make the luminance of illumination device 202 discernible in association with the individual lines.

The illumination device luminance distribution memory 104 is written with the luminance distribution information of illumination device 202 shown in FIG. 16. In other words, the illumination device luminance distribution memory 104 has an address corresponding to a line number on the liquid crystal panel and an output corresponding to a luminance level.

The liquid crystal panel drive controller 101 responds to the timing signal sent from the image signal source to calculate a line number to which an image is written and sends the line number to an address of the illumination device luminance distribution memory 104.

Then, a signal indicative of a luminance level of illumination device 202 corresponding to the line is delivered out of the illumination device luminance distribution memory 104 to the image signal conversion circuit 103.

The image signal conversion circuit 103 compares the luminance signal of illumination device 202 sent from the illumination device luminance distribution memory 104 with an inputted image signal and converts the image signal in such a way that desired luminance can be displayed on the liquid crystal panel 201 and delivers the thus converted signal to the liquid crystal panel 201.

Turning to FIG. 17, transmission factors associated with the individual lines are distributed as shown therein in the scanning direction when an intermediate level of luminance on the liquid crystal panel is displayed all over the screen. In this case, the transmission factors at the individual positions on the liquid crystal panel 201 are so distributed as to cancel the luminance distribution of the illumination device 202.

Namely, the transmission factor of liquid crystal panel 201 is lowered at a position where the luminance of illumination device 202 is high whereas the transmission factor of liquid crystal panel 201 is raised at a position where the luminance of illumination device 202 is low.

Referring to FIG. 18, the brilliance on the liquid crystal panel 201 is distributed in the scanning direction as shown therein. The luminance unevenness of illumination device 202 can be absorbed by the transmission factor of liquid crystal to assure a uniform display.

As described above, in the present embodiment, through the use of the light barrier, the intrusion of rays of light emanating from each unit to a different unit can be suppressed appropriately and besides the luminance unevenness generated on the illumination device 202 by the light barrier can be prevented from affecting the display by controlling the transmission factor of liquid crystal panel 201 at individual positions thereof.

It should be further understood by those skilled in the art that although the foregoing description has been made on embodiments of the invention, the invention is not limited thereto and various changes and modifications may be made without departing from the spirit of the invention and the scope of the appended claims.

1. An illumination device partitioned into a plurality of areas so that lighting of light sources provided in association with the individual areas may be controlled area by area and having a light barrier for appropriately suppressing intrusion of rays of light emanating from each area into another area or a light transmission type display apparatus provided with the same,
wherein said illumination device includes a light diffuser and in accordance with light flux emanating from the individual areas and reaching the individual positions of said light diffuser, the transmission factor at the individual positions of said light diffuser is changed.

2. An illumination device partitioned into a plurality of areas so that lighting of light sources provided in association with the individual areas may be controlled area by area and having a light barrier for appropriately suppressing intrusion of rays of light emanating from each area into another area or a light transmission type display apparatus provided with the same,
wherein said illumination device includes a light diffuser and in accordance with light flux emanating from the individual areas and reaching the individual position of said light diffuser, the thickness at the individual positions of said light diffuser is changed.

3. An illumination device partitioned into a plurality of areas so that lighting of light sources provided in association with individual areas may be controlled area by area and having a light barrier for appropriately suppressing intrusion of rays of light emanating from each area into another area or a light transmission type display apparatus provided with the same,
wherein said illumination device includes a light diffuser and in accordance with light flux emanating from the individual areas and reaching individual positions of said light diffuser, the density of light scattering particles at the individual positions of said light diffuser is changed.

4. An illumination device partitioned into a plurality of areas so that lighting of light sources provided in association with individual areas may be controlled area by area or a light transmission type display apparatus provided with the same,
wherein a light emitting diode is used as the light source and a prism sheet is arranged on the light emitting surface of said light emitting diode.

5. An illumination device partitioned into a plurality of areas so that lighting of light sources provided in association with individual light sources may be controlled area by area or a light transmission type display apparatus provided with the same,
wherein a light emitting diode is used as the light source and a prism sheet is arranged on the light emitting surface of said light emitting diode, and said illumination device includes a light diffuser and the transmission factor at individual positions of said light diffuser is changed in accordance with light flux emanating from individual areas and reaching the individual positions of said light diffuser.

6. An illumination device partitioned into a plurality of areas so that lighting of light sources provided in association with individual areas may be controlled area by area or a light transmission type display apparatus provided with the same,
wherein a light emitting diode is used as the light source, having a prism sheet laid on its light emitting surface, said illumination device includes a light diffuser and the thickness at individual positions of said light diffuser is changed in accordance with light flux emanating from the individual areas and reaching the individual positions of said light diffuser.

7. An illumination device partitioned into a plurality of areas so that lighting of light sources provided in association with individual areas may be controlled area by area,
wherein a light emitting diode is used as the light source, having a prism sheet laid on its light emitting surface, said illumination device includes a light diffuser and the density of light scattering particles at individual positions of said light diffuser is changed in accordance with light flux emanating from the individual areas and reaching the individual positions of said light diffuser.

8. An illumination device partitioned into a plurality of areas so that lighting of light sources provided in association with individual areas may be controlled area by area or a light transmission type display apparatus provided with the same,
wherein a light emitting diode is used as the light source and its light emitting surface is shaped unevenly.

9. An illumination device partitioned into a plurality of areas so that lighting of light sources provided in association with individual areas may be controlled area by area or a light transmission type display apparatus provided with the same,
wherein a light emitting diode is used as the light source, having its light emitting surface shaped unevenly, said illumination device includes a light diffuser and the transmission factor at individual positions of said light diffuser is changed in accordance with light flux emanating from the individual areas and reaching the individual positions of said light diffuser.

10. An illumination device partitioned into a plurality of areas so that lighting of light sources provided in association with individual areas may be controlled area by area or a light transmission type display apparatus provided with the same,
wherein a light emitting diode is used as the light source, having its light emitting surface shaped unevenly, said illumination device includes a light diffuser and the thickness at individual positions of said light diffuser is changed in accordance with light flux emanating from the individual areas and reaching the individual positions of said light diffuser.

11. An illumination device partitioned into a plurality of areas so that lighting of light sources provided in association with individual areas may be controlled area by area or a light transmission type display apparatus provided with the same,
wherein a light emitting diode is used as the light source, having its light emitting surface shaped unevenly, said illumination device includes a light diffuser and the density of light scattering particles at individual positions of said light diffuser is changed in accordance with light flux emanating from the individual areas and reaching the individual positions of said light diffuser.

12. An illumination device partitioned into a plurality of areas so that lighting of light sources provided in association with individual areas may be controlled area by area and having a light barrier for appropriately suppressing intrusion of rays of light emanating from each area into another area or a light transmission type display apparatus provided with the same,
wherein a controller for driving said light transmission type display apparatus is provided and said controller includes a memory written with data of luminance distribution on the surface of a light diffuser said illumination device has.

13. An illumination device partitioned into a plurality of areas so that lighting of light sources provided in association with individual areas may be controlled area by area or a light transmission type display apparatus provided with the same,
wherein a light emitting diode is used as the light source, having its light emitting surface laid with a prism sheet and a controller for driving said light transmission type display apparatus is provided including a memory written with data of luminance distribution on the surface of a light diffuser said illumination device has.

14. An illumination device partitioned into a plurality of areas so that lighting of light sources provided in association with individual areas may be controlled area by area or a light transmission type display apparatus provided with the same,
wherein a light emitting diode is used as the light source, having its light emitting surface shaped unevenly and a controller for driving said light transmission type display apparatus is provided including a memory written with data of luminance distribution on the surface of a light diffuser said illumination device has.

15. An illumination device or a light transmission type display apparatus provided with the same according to claim 1, wherein a light emitting diode is used as the light source and a prism sheet is laid on its light emitting surface.

16. An illumination device or a light transmission type display apparatus provided with the same according to claim 1, wherein a light emitting diode is used as the light source and its light emitting surface is shaped unevenly.

17. An illumination device partitioned into a plurality of areas so that lighting of light sources provided in association with individual areas may be controlled area by area and having a light barrier for appropriately suppressing intrusion of rays of light emanating from each area into another area or a light transmission type display apparatus provided with the same,
wherein a light emitting diode is used as the light source, having its light emitting surface laid with a prism sheet and a controller for driving said light transmission type display apparatus is provided including a memory written with data of luminance distribution on the surface of a light diffuser said illumination device has.

18. An illumination device partitioned into a plurality of areas so that lighting of light sources provided in association with individual areas may be controlled area by area and having a light barrier for appropriately suppressing intrusion of rays of light emanating from each area into another or a light transmission type display apparatus provided with the same,
wherein a light emitting diode is used as the light source, having its light emitting surface shaped unevenly and a controller for driving said light transmission type display apparatus is provided including a memory written with data of luminance distribution on the surface of a light diffuser said illumination device has.

19. An illumination device or a light transmission type display apparatus provided with the same according to claim 15, wherein a controller for driving said light transmission type display apparatus is provided including a memory written with data of luminance distribution on the surface of said light diffuser said illumination device has.

20. An illumination device or a light transmission type display apparatus provided with the same according to claim 1, wherein said light barrier is constructed of a mold resin member of a light emitting diode.

21. An illumination device or a light transmission type display apparatus provided with the same according to claim 4, wherein said prism sheet is used as a light condensing sheet.
